(19) United States
(12) Patent Application Publication
(10) Pub. No.: US 2022/0266290 A1
(43) Pub. Date: Aug. 25, 2022

(54) Applicator

(71) Applicants: Natlan McDonald, Brisbane (AU); The Stik & Co Holdings Pty Ltd, Draper (AU)

(72) Inventor: Natlan McDonald, Brisbane (AU)

(21) Appl. No.: 17/622,317

(22) PCT Filed: Jun. 26, 2020
(86) PCT No.: PCT/AU2020/050658

§ 371 Date: Dec. 23, 2021

(30) Foreign Application Priority Data
Jul. 3, 2019 (AU) 2019204795

(51) Int. Cl. B05C 17/005; B65D 35/38; B65D 35/46; B65D 47/20; B65D 47/42

(52) U.S. Cl. CPC B05C 17/00583; B65D 35/38; B65D 35/46; B65D 47/2031; B65D 47/42; B65D 2547/063

(57) ABSTRACT

Provided is an applicator for applying a solvent cement, the applicator having a deformable container for containing the solvent cement, a nozzle, a valve located between the container, and the nozzle. The valve is changeable between an open condition where the solvent cement can move from the container to the nozzle and a closed condition where solvent cement is inhibited from moving from the container to the nozzle, and a disperser attached to the nozzle. The disperser is adapted to disperse solvent cement that flows from the nozzle.

### CROSS-REFERENCE TO RELATED APPLICATIONS

This application is the United States national phase of International Application No. PCT/AU2020/050658 filed Jun. 26, 2020, and claims priority to Australian Patent Application No. 2019204795 filed Jul. 3, 2019, the disclosures of which are hereby incorporated by reference in their entirety.

### BACKGROUND OF THE INVENTION

### Field of Invention

The present invention relates to an applicator. The present invention has particular but not exclusive application for applying a solvent cement to plumbing fixtures. The patent specification describes this use but it is by way of example only and the invention is not limited to this use.

### Description of Related Art

Polyvinyl chloride (PVC) pipes and PVC fittings are commonly used in plumbing. To join PVC pipes and/or PVC fittings together typically requires a solvent cement to be applied to at least one part that is to be joined together and then connecting the parts that are to be joined. Typically the parts will have a male and female portion that are to be joined together. It is important that the solvent cement forms a complete seal between the male and female parts.

The solvent cement typically softens and dissolves the top layer of the PVC material, essentially untangling the polymer chain. The pieces to be joined are then pressed together, and the solvent evaporates, the freed molecules of one piece bond with the free molecules of the other piece, creating one continuous piece.

The solvent cement is typically applied to the pieces by dipping a brush into a tin of solvent cement and applying the solvent to the pieces to be joined.

A problem with applying the solvent cement is that it can be difficult to apply the required amount of solvent to a piece in one go, often requiring the brush to be dipped into the tin of solvent multiple times before the pieces are adequately covered to be joined together. This can lead to the tin of solvent tipping over and causing a mess, or excess solvent dripping from the brush and causing a mess.

### SUMMARY OF THE INVENTION

It is an object of the present invention to overcome or at least alleviate one or more of the above mentioned problems with applying adhesive to and/or provide the consumer with a useful or commercial choice.

In one aspect, the present invention broadly resides in an applicator for applying a solvent cement, the applicator having

a deformable container for containing the solvent cement;

a nozzle;

a valve located between the container and the nozzle, the valve changeable between an open condition where the solvent cement can move from the container to the nozzle and a closed condition where solvent cement is inhibited from moving from the container to the nozzle; and

a disperser attached to the nozzle, the disperser adapted to disperse solvent cement that flows from the nozzle.

Preferably, the container is made of a plastic material. Preferably the container is squeezable by a user. Preferably the container is adapted to return to its original condition after it has been squeezed or deformed. Preferably the container is made of a plastic material that is resistant to the solvent cement. Preferably the applicator is adapted to apply a primer. Preferably the container is adapted to contain the primer. In one embodiment, the container is made of a high density polyethylene and/or polypropylene material.

Preferably the nozzle is separate to the container. Preferably the nozzle can be attached and detached from the container. Preferably the nozzle can be attached and detached from the container via a threaded connection. Preferably when the nozzle is detached from the container, solvent cement can be introduced into the container. In another embodiment, the nozzle is part of the container. Preferably in this embodiment, the container includes an opening so that solvent cement can be introduced into the container. In a further embodiment the container includes an opening so that solvent cement can be introduced into the container. Preferably the opening is located at an end of the container opposite the nozzle.

Preferably the nozzle has a plurality of openings. Preferably the solvent cement can flow through the plurality of openings to the disperser. In one embodiment, the nozzle has a single opening in fluid communication with the disperser.

Preferably the nozzle is made of plastic. Preferably the nozzle is made of the same material as the container. In another embodiment, the nozzle is made of a metallic material. In another embodiment, the nozzle is made of polypropylene, acetal and/or high density polyethylene.

In one embodiment, the nozzle includes a threaded portion adapted to engage with a threaded portion of the disperser.

Preferably the valve is a silicone valve. More preferably the valve is a silicone slit valve. Preferably the valve is a pressure activated valve. Preferably the valve enables fluid to pass therethrough when a predefined pressure differential is reached between a first side and a second side of the valve. Preferably when the pressure of the solvent cement in the container reaches a predefined amount, the valve opens to enable the solvent cement to flow from the container. Preferably a user squeezes the container to increase the pressure of the solvent cement. In one embodiment, the valve is a duckbill valve. In another embodiment, the valve is an umbrella check valve. In one embodiment, the valve is a spring loaded valve. More preferably the valve is a ball bearing and spring type valve. Preferably the valve is located within at least a portion of the nozzle. In one embodiment, the valve is made substantially of EDPM and/or fluro rubber material.

In one embodiment, the applicator includes a pump or a pump portion on the container that a user can press to increase the pressure in the container.

Preferably the disperser is made of or includes a foam material. Preferably the disperser is made of or includes a plastic foam material. In another embodiment, the disperser is made of a rubber foam material. Preferably the disperser disperses solvent cement flowing from the nozzle, to a surface of the disperser. Preferably the disperser covers a portion of the nozzle. Preferably the disperser is substantially circular in cross section. In one embodiment, the disperser includes a shaped portion. Preferably the shaped portion is arcuate. Preferably the shaped portion conforms to an arcuate surface of a PVC pipe to which the solvent cement is to be applied. Preferably the foam material is a sponge. In one embodiment, the sponge is a natural sponge. In another embodiment, the disperser is made of or includes cotton. Preferably the disperser includes one or more cotton discs. Preferably the one or more cotton discs are at least partially locatable about a portion of the nozzle. More preferably the disperser includes a plurality of cotton discs. In a further embodiment, the disperser is made of or includes a permeable material. More preferably the disperser includes one or more discs of permeable material.

Preferably the disperser is releasably attached to the nozzle. In one embodiment, the disperser includes a threaded portion which is adapted to engage with a threaded portion of the nozzle.

In another aspect, the present invention broadly resides in a solvent cement applicator having

a deformable container for containing the solvent cement;

a nozzle;

a disperser adjacent to the nozzle; and

a valve located between the container and the disperser, the valve changeable between an open condition where the solvent cement can move from the container to the disperser and a closed condition where solvent cement is inhibited from moving from the container to the disperser; and

wherein in use a user squeezes the container to increase the pressure of the solvent cement in the container, and when the pressure reaches a predefined amount, the valve opens to enable the solvent cement to flow from the container to the disperser.

Preferably the valve is located between the container and the nozzle. In another embodiment, the valve is located between the nozzle and the disperser. In a further embodiment, the valve is located within the nozzle. In another embodiment, the valve is located at least partially within the nozzle.

In a further aspect, the present invention broadly resides in a method of using an applicator as described in this specification, to apply solvent cement to a work piece, including the steps of

introducing solvent cement into the container;

squeezing the container to increase the pressure of the solvent cement and change the valve to the open condition; and

applying solvent cement from the disperser to the work piece.

In another aspect, the present invention broadly resides in a solvent cement applicator system having an applicator, the applicator having:

a deformable container for containing the solvent cement;
a nozzle in fluid communication with the container;
a valve located between the container and the nozzle; and
a disperser adjacent to the nozzle; and

an applicator pouch into which the applicator can be placed to store the applicator when not in use.

Preferably the applicator pouch is made of silicone. Preferably the applicator pouch includes a belt loop on a side thereof to enable the applicator pouch to be attached to a belt or the like. Preferably the belt loop is made of steel. Preferably the applicator pouch is tapered from an opening to a lower portion thereof. Preferably, when the applicator is located in the applicator pouch, the disperser contacts the applicator pouch. Preferably, when the disperser contacts the applicator pouch, the solvent cement in or on the disperser is inhibited from drying out. In one embodiment, the applicator pouch is made of a low density polyethylene and/or high density polyethylene material.

Preferably the applicator pouch provides a substantially airtight seal between the container and the applicator pouch when the applicator is located in the applicator pouch.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a schematic exploded view of an applicator according to an embodiment of the present invention;

FIG. 2 is a schematic view of a nozzle according to a second embodiment of the invention;

FIG. 3 is a schematic side view of a disperser according to a third embodiment of the invention; and

FIG. 4 is a schematic view of a solvent cement applicator system according to an embodiment of the present invention.

### DESCRIPTION OF THE INVENTION

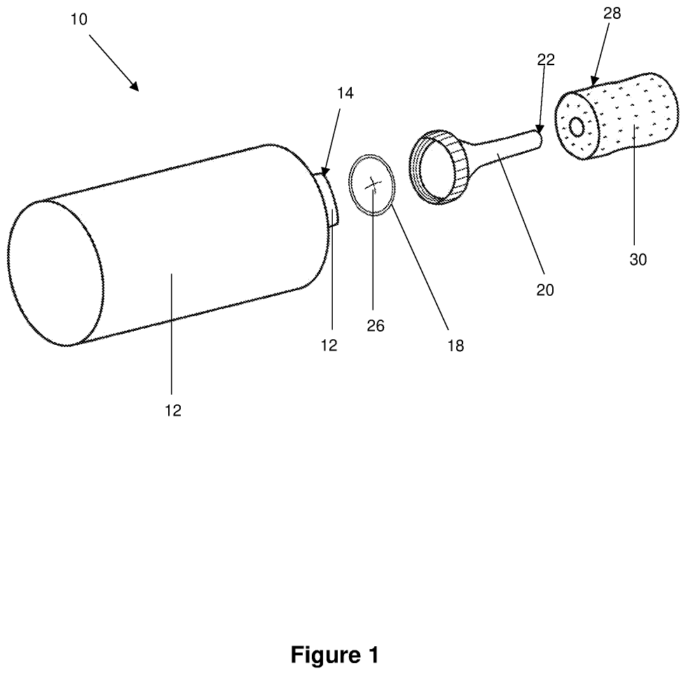

With reference to FIG. 1 there is shown an applicator 10 according to an embodiment of the present invention, in an exploded view. The applicator 10 includes a container in the form of a plastic bottle 12. The plastic bottle 12 has an opening 14 which has a threaded portion 16.

The threaded portion 16 of the opening 14 is adapted to engage with a threaded portion 18 of a nozzle 20. The nozzle 20 has an opening 22. The nozzle 20 is made of the same material as the plastic bottle 12.

A valve in the form of a silicone slit valve 24 is located between the opening 14 and a portion of the nozzle 20. The silicone slit valve 24 has two slits 26 in the form of a +. When the silicone slit valve 24 is subject to a predetermined pressure, the silicone slit valve 24 changes from a closed condition (shown) to an open condition (not shown). In the open condition (not shown) the silicone slit valve 24 enables solvent cement to flow from the container to the nozzle 20.

The applicator 10 includes a disperser in the form of a plastic foam disperser 26. The plastic foam disperser 28 fits over the nozzle 20. An outside surface 30 of the plastic foam disperser 28 is in fluid communication with the opening 22 of the nozzle 20, such that solvent cement can flow from the opening 22 of the nozzle 20 through the plastic foam disperser 28, to the outside surface 30 of the plastic foam disperser 28.

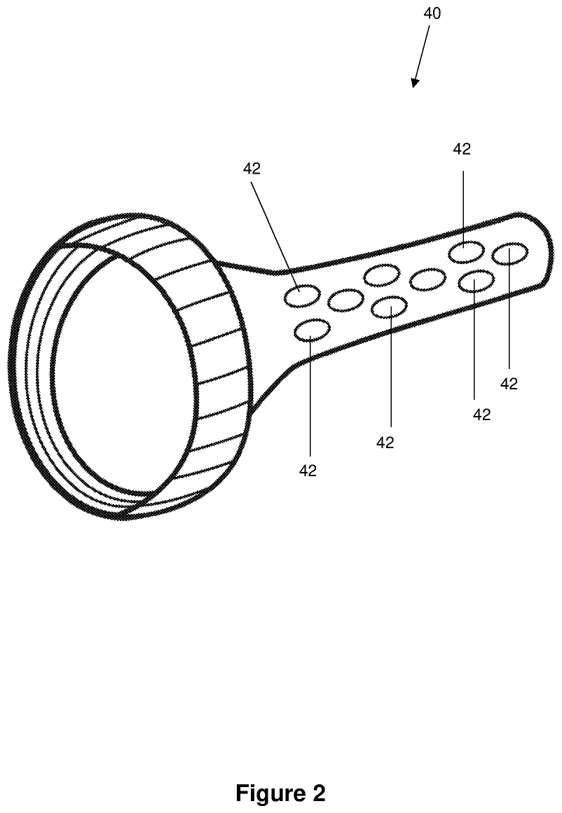

With reference to FIG. 2 there is shown a nozzle 40 according to a second embodiment of the present invention. The nozzle 40 is similar to the nozzle 20 of FIG. 1, except that the nozzle 40 has a plurality of openings 42. The plurality of openings 42 enable solvent cement to flow evenly from the nozzle 40 to a disperser (not shown) similar to disperser 28 in FIG. 1.

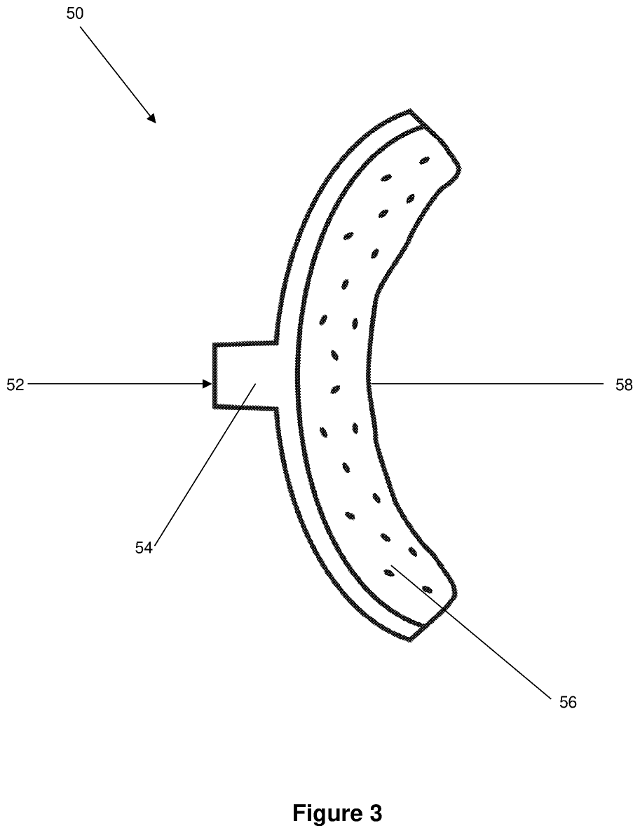

With reference to FIG. 3 there is shown a disperser 50 according to a third embodiment of the present invention. The disperser 50 has an opening 52 which is adapted to attach to a nozzle (not shown) similar to the nozzle 20 in FIG. 1. The disperser 50 has a hollow rigid portion 54, and a plastic foam portion 56. An outer surface 58 of the plastic foam portion 56 is in fluid communication with the opening 52, such that solvent cement which flows into the disperser 50 via the opening 52 can flow through the hollow portion 54, through the plastic foam portion 56 to the outer surface 58.

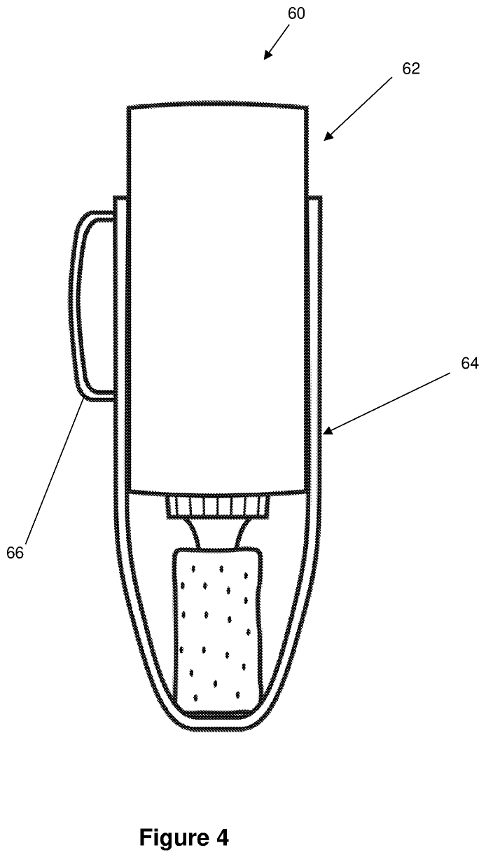

With reference to FIG. 4, there is shown a schematic view of a solvent cement applicator system 60 according to an embodiment of the present invention. The solvent cement applicator system 60 includes an applicator 62. The applicator 62 is similar to the applicator 10 in FIG. 1. The solvent cement applicator system 60 includes an applicator pouch 64 into which the applicator 62 can be placed to store the applicator 62 when not in use.

The applicator pouch 64 has a belt loop 66 so that the applicator pouch 64 can be worn on a user's belt (not shown). The applicator pouch 64 is made of silicone and provides a substantially airtight seal between the applicator pouch 64 and the applicator 62.

In use, with reference to FIG. 1, solvent cement is introduced into the plastic bottle 12 via the opening 14. The silicone slit valve 24 is located between the opening 14 and a portion of the nozzle 20 prior to the nozzle being attached to the plastic bottle via threaded portions 16 and 18. The disperser 28 is located on the nozzle 20.

To apply solvent cement from the disperser 28 to a work piece (not shown), the applicator 10 is typically held in a downward orientation with the disperser 28 facing downward. The plastic bottle 12 is squeezed by the user to increase the pressure in the plastic bottle 12. The increase of pressure causes the silicone slit valve 24 to change to the open condition so that the solvent cement can flow from the plastic bottle 12 through the nozzle 20 and through the disperser 28 to the external surface 30 of the disperser 28.

### Advantages

An advantage of the preferred embodiment of the applicator includes a consistent supply of solvent cement. Another advantage of the preferred embodiment of the applicator includes the ability to prevent excess solvent cement exiting the applicator. A further advantage of an embodiment of the applicator includes a quick refill of solvent cement into the container. Another advantage of the preferred embodiment of the applicator includes the ability to replace the disperser. An advantage of the preferred embodiment of the applicator system includes the pouch providing convenient access to the applicator and inhibiting drying out of the cement solvent on or in the disperser when the applicator is located in the pouch. A further advantage of an embodiment of the applicator with a valve located at least partially within the nozzle includes the ability to replace the disperser, nozzle and valve.

### Variations

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. An applicator for applying a solvent cement, the applicator comprising:
a deformable container for containing the solvent cement;
a nozzle;
a valve located between the container and the nozzle, the valve changeable between an open condition where the solvent cement can move from the container to the nozzle and a closed condition where solvent cement is inhibited from moving from the container to the nozzle; and
a disperser attached to the nozzle, the disperser adapted to disperse solvent cement that flows from the nozzle.

2. The applicator as claimed in claim 1, wherein the valve is a pressure activated valve.

3. The applicator as claimed in claim 1, wherein the valve enables fluid to pass therethrough when a predefined pressure differential is reached between a first side and a second side of the valve.

4. The applicator as claimed in claim 1, wherein when the pressure of the solvent cement in the container reaches a predefined amount, the valve opens to enable the solvent cement to flow from the container.

5. The applicator as claimed in claim 4, wherein in use a user squeezes the container to increase the pressure of the solvent cement.

6. The applicator as claimed in claim 1, wherein the valve is a silicone slit valve.

7. The applicator as claimed in claim 1, wherein in use when a user squeezes the container, the pressure of the solvent cement in the container increases, and when the pressure reaches a predefined amount, the valve opens to enable the solvent cement to flow from the container to the nozzle.

8. The applicator as claimed in claim 1, wherein the nozzle has a plurality of openings, enabling the solvent cement, in use, to flow through the plurality of openings to the disperser.

9. The applicator as claimed in claim 1, wherein the nozzle can be attached and detached from the container.

10. The applicator as claimed in claim 9, wherein the nozzle can be attached and detached from the container via a threaded connection.

11. The applicator as claimed in claim 1, wherein the nozzle includes a threaded portion adapted to engage with a threaded portion of the disperser.

12. The applicator as claimed in claim 1, wherein the disperser is made of or includes a foam material.

13. The applicator as claimed in claim 1, wherein the container is adapted to return to its original condition after it has been squeezed or deformed by a user.

14. The applicator as claimed in claim 1, wherein the container is made of a plastic material.

15. A solvent cement applicator comprising:
a deformable container for containing the solvent cement;
a nozzle;
a disperser adjacent to the nozzle; and
a valve located between the container and the disperser, the valve changeable between an open condition where the solvent cement can move from the container to the disperser and a closed condition where solvent cement is inhibited from moving from the container to the disperser; and
wherein in use a user squeezes the container to increase the pressure of the solvent cement in the container, and when the pressure reaches a predefined amount, the valve opens to enable the solvent cement to flow from the container to the disperser.

16. The solvent cement applicator as claimed in claim 15, wherein the valve is located at least partially within the nozzle.

17. A solvent cement applicator system comprising:
an applicator, the applicator comprising:
a deformable container for containing the solvent cement;
a nozzle in fluid communication with the container;
a valve located between the container and the nozzle; and
a disperser attached to the nozzle; and
an applicator pouch into which the applicator can be placed to store the applicator when not in use.

18. The solvent cement applicator system as claimed in claim 17, wherein the applicator pouch is made of silicone and includes a belt loop on a side thereof to enable the applicator pouch to be attached to a belt or the like.

19. The solvent cement applicator system as claimed in claim 17, wherein the applicator pouch provides a substantially airtight seal between the container and the applicator pouch when the applicator is located in the applicator pouch.

20. A method of using an applicator as claimed in claim 1, to apply solvent cement to a work piece, comprising the steps of:
introducing solvent cement into the container;
squeezing the container to increase the pressure of the solvent cement and change the valve to the open condition; and
applying solvent cement from the disperser to the work piece.
